(19) United States
(12) Patent Application Publication
(10) Pub. No.: US 2014/0140054 A1
(43) Pub. Date: May 22, 2014

(54) Multi-Structure Pore Membrane and Pixel Structure

(71) Applicants: Akinori Hashimura, Vancouver, WA (US); Douglas J. Tweet, Camas, WA (US); Apostolos T. Voutsas, Portland, OR (US)

(72) Inventors: Akinori Hashimura, Vancouver, WA (US); Douglas J. Tweet, Camas, WA (US); Apostolos T. Voutsas, Portland, OR (US)

(21) Appl. No.: 13/682,535

(22) Filed: Nov. 20, 2012

(51) Int. Cl. C23C 28/00; F21V 9/16

(52) U.S. Cl. CPC C23C 28/00; F21V 9/16; B82Y 40/00
USPC 362/231; 205/112; 977/890

(57) ABSTRACT

Methods are provided for fabricating a multi-structure pore membrane. In one method, an anodized aluminum oxide (AAO) template is formed with an array of pores exposing underlying regions of a conductive layer top surface. A plurality of photoresist layers is patterned to sequentially expose a plurality of AAO template sections. Each exposed AAO template section is sequentially etched to widen pore diameters, so that each AAO template section may be associated with a corresponding unique pore diameter. A target material is deposited in the pores of the AAO template and, as a result, an array of target material structures is formed on the top surface, where the target material structures associated with each AAO template section have a corresponding diameter. Also provided is a multi-structure pixel device formed with subpixels having different structure dimensions.

### RELATED APPLICATION

The application is a Continuation-in-Part of a pending application entitled, PLASMONIC REFLECTIVE DISPLAY FABRICATED USING ANODIZED ALUMINUM OXIDE, invented by Aki Hashimura et al., Ser. No. 13/449,370, filed on Apr. 19, 2012, Attorney Docket No. SLA3106;

which is a Continuation-in-Part of a pending application entitled, METHOD FOR IMPROVING METALLIC NANOSTRUCTURE STABILITY, invented by Aki Hashimura et al., Ser. No. 13/434,548, filed on Mar. 29, 2012, Attorney Docket No. SLA3026;

which is a Continuation-in-Part of a pending application entitled, PLASMONIC ELECTRONIC SKIN, invented by Tang et al., Ser. No. 12/836,121, filed on Jul. 14, 2012, Attorney Docket No. SLA2752;

which is a Continuation-in-Part of a pending application entitled, PLASMONIC DEVICE TUNED USING PHYSICAL MODULATION, invented by Tang et al., Ser. No. 12/646,585, filed on Dec. 23, 2009, Attorney Docket No. SLA2686;

which is a Continuation-in-Part of a pending application entitled, PLASMONIC DEVICE TUNED USING LIQUID CRYSTAL MOLECULE DIPOLE CONTROL, invented by Tang et al., Ser. No. 12/635,349, filed on Dec. 10, 2009, Attorney Docket No. SLA2711;

which is a Continuation-in-Part of a pending application entitled, PLASMONIC DEVICE TUNED USING ELASTIC AND REFRACTIVE MODULATION MECHANISMS, invented by Tang et al., Ser. No. 12/621,567, filed on Nov. 19, 2009, Attorney Docket No. SLA2685;

which is a Continuation-in-Part of a pending application entitled, COLOR-TUNABLE PLASMONIC DEVICE WITH A PARTIALLY MODULATED REFRACTIVE INDEX, invented by Tang et al., Ser. No. 12/614,368, filed on Nov. 6, 2009, Attorney Docket No. SLA2684. All the above-referenced applications are incorporated herein by reference.

### BACKGROUND OF THE INVENTION

1. Field of the Invention

This invention generally relates to nanostructure devices and, more particularly, nanostructure membranes suitable for fabrication in display pixel applications.

2. Description of the Related Art

Reflective display or color-tunable device technology is attractive primarily because it consumes substantially less power than liquid crystal displays (LCDs) and organic light emitting diode (OLED) displays. A typical LCD used in a laptop or cellular phone requires internal (backlight) illumination to render a color image. In most operating conditions the internal illumination that is required by these displays is in constant competition with the ambient light of the surrounding environment (e.g., sunlight or indoor overhead lighting). Thus, the available light energy provided by these surroundings is wasted, and in fact, the operation of these displays requires additional power to overcome this ambient light. In contrast, reflective display technology makes good use of the ambient light and consumes substantially less power.

The full range of colors produced by plasmon resonances resulting from metal nanostructures has been known since ancient times as a means of producing stained colored glass. For instance, the addition of gold nanoparticles to otherwise transparent glass produces a deep red color. The creation of a particular color is possible because the plasmon resonant frequency is generally dependent upon the size, shape, material composition of the metal nanostructure, as well as the dielectric properties of the surrounding environment. Thus, the optical absorption and scattering spectra (and therefore the color) of a metal nanostructure can be varied by altering any one or more of these characteristics. The parent applications listed above describe means of electronically controlling these color-producing characteristics.

The properties of metallic nanoparticles have drawn significant attention due to their application in photonics and electro-optics, as well as their potential application in biological/chemical sensors and renewable energy. Moreover, the fabrication of periodic metallic nanoparticle arrays for applications in photonics utilizing their localized surface plasmon resonance (LSPR) properties has been extensively studied in recent years. Among various processing techniques, depositing a film of metal on a nano-size patterned mask and using a lift-off process to remove the sacrificial layer is becoming a widely used technique, because it allows for fabricating nanoparticles with precisely controlled shape, size, and particle spacing. Moreover, advanced research has revealed that ordered array nanostructures have improved quantum characteristics utilized in LSPR properties, or photoluminescence and electroluminescence properties of semiconductor nanophosphors. Therefore, a method to achieve ordered nanoparticles and nanostructures is of significant importance.

One method of forming nanoparticles in an ordered array which has been proposed is a nano-imprinting process using a mold to generate ordered dot patterns on poly methyl methacrylate (PMMA) mask layers. After forming an array of nanostructures to a predefined depth, the residual PMMA layers at the bottom of the pattern are removed to reveal the surface underneath the mask. The metallic nanoparticles are formed by depositing the desired metals and removing the PMMA mask layers in a solution to lift off the residual metals deposited on the mask. According to this technique, the size and spacing of the nanostructures are limited by the photolithography patterning capability of the mold. Also, the manufacturing cost is high due to expensive capital costs associated with the nanoimprint lithography process. Alternatively, nano-scale structures can be patterned using e-beam lithography. However, this process is extremely slow and costly.

Among other processing techniques, forming an array of ordered nanostructures using self-assembly solution process is desired due to low capital cost without sacrificing manufacturing scalability. It is possible to anodize an aluminum layer in an electrolyte solution to form aluminum oxide pores with diameters of several nanometers to several hundred of nanometers arranged in hexagonal order. This anodized aluminum oxide (AAO) template can then be used as a mask to generate an array of nanoparticles on a substrate by depositing desired materials and lifting off the mask to form the nanostructures.

However, conventionally known techniques using an AAO template to form nanostructures are limited to the formation of a single pattern of pores, and therefore, only one set of ordered array of particles. Some research has been done to initiate the patterning of the aluminum layer with a hard mask using silicon dioxide [Zhao et al, J. of Electrochemical Society, 152 (10) B411-B414 (2005)] or metallic tantalum [Zhao et al, Nanotechnology 17 (2006) 35-39] to generate AAO template selectively on a substrate. However, this process is isotropic in nature, anodizing the aluminum underneath the hard mask, either creating unwanted pores or severe undercut underneath the mask. This is especially evident in very thick Al films (e.g. >100 microns). Further, Zhou does not disclose a means for obtaining different pore diameters and/or different pitches between pores on a single substrate.

It would be advantageous if a method existed for forming more than one set of ordered particle arrays with different diameter sizes or pitches on the same substrate, for applications like displays where different colored pixels require different nanostructure sizes.

### SUMMARY OF THE INVENTION

Described herein are a multi-structure pore membrane and a manufacturing method for creating different pore sizes of anodized aluminum oxide on a single substrate. Moreover, the pore membrane can be used to form multiple ordered arrays of nanostructures with different sizes on the same substrate. In one aspect, a multi-structure pore membrane includes at least one portion with an ordered array of pores having larger diameters than the ordered array of pores on other portions of the same membrane. Moreover, the pitch of pores may be made the same for all the pores on the membrane, or varied between membrane portions. Another aspect includes manufacturing methods to form a multi-ordered array of nanoparticles on the same substrate. The methods include the step of generating an anodized aluminum oxide (AAO) template from an aluminum metal layer deposited on a substrate. The AAO template is patterned using conventional lithography with portions of the template covered with photoresist. Steps to widen the pores or pitch are pursued using etching and anodizing chemistries, respectively. A target material is deposited on the exposed pore regions, and nanostructures are formed at the bottom of the pores. The photoresist and the excess materials deposited on the photoresist layer are removed in a solvent solution. The patterning of the AAO template, and photoresist lift-off steps are repeated as necessary to generate a multiple-ordered array of nanoparticles on a substrate.

Accordingly, a method is provided for fabricating a multi-structure pore membrane. An AAO template is formed with an array of pores exposing underlying regions of a conductive layer top surface. A plurality of photoresist layers is patterned to sequentially expose a plurality of AAO template sections. Each exposed AAO template section is sequentially etched to widen pore diameters, so that each AAO template section may be associated with a corresponding unique pore diameter. A target material is deposited in the pores of the AAO template and, as a result, an array of target material structures is formed on the top surface, where the target material structures associated with each AAO template section have a corresponding diameter.

In one variation, the method forms an aluminum film over a conductive layer top surface, which is patterned using a plurality of photoresist layers to sequentially expose a plurality of aluminum film sections. Each aluminum film section is sequentially anodized with a chemistry to form a plurality of AAO template sections with corresponding pore features associated with pore diameter, pitch between pores, and both pore diameter and pitch between pores. After depositing a target material in the pores of the AAO template sections, an array of target material structures is formed on the top surface, with the target material structures associated with each AAO template section having a corresponding structure feature related to material structure diameter, pitch between material structures, and both material structure diameter and pitch between material structures.

Additional details of the above-described methods and a multi-structure pixel device are presented below.

### BRIEF DESCRIPTION OF THE DRAWINGS

FIGS. 1A through 1G are partial cross-sectional and plan views of a multi-structure pixel device.

FIGS. 2A and 2B are diagrams depicting, respectively, long-range hexagonal and short-range hexagonal nanoparticle patterns.

FIG. 3 is a partial cross-sectional view of a membrane structure, which may also be referred to as a multi-structure pixel device.

FIG. 4 is a partial cross-sectional view depicting of an ordered array of nanostructures with different diameters formed using the membrane structure of FIG. 3.

FIG. 5 is a plan view depicting ordered nanostructures arranged in a pixel configuration using an anodized aluminum oxide template as a masking layer.

FIG. 6 is a flowchart illustrating a method for preparing a membrane structure and forming multiple ordered arrays of structures with different sizes.

FIG. 7 is a flowchart illustrating a first method for fabricating a multi-structure pore membrane.

FIG. 8 is a flowchart illustrating a second method for fabricating a multi-structure pore membrane.

FIG. 9 is a flowchart illustrating a third method for fabricating a multi-structure pore membrane.

### DETAILED DESCRIPTION

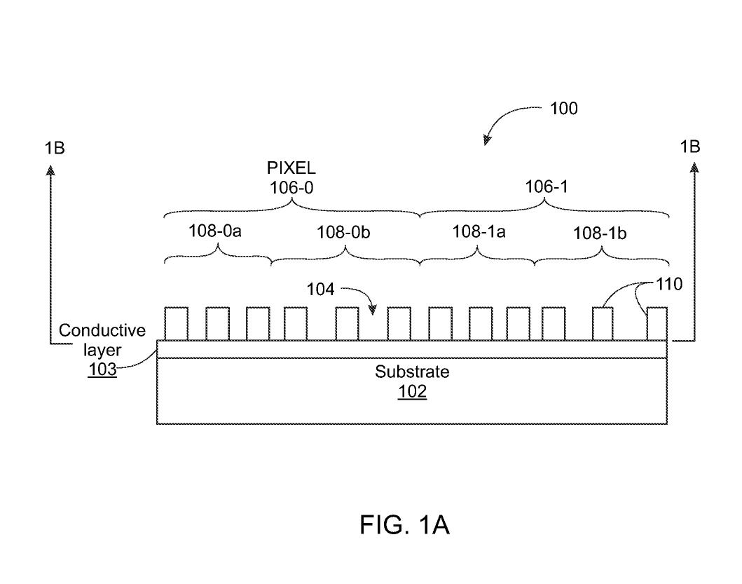

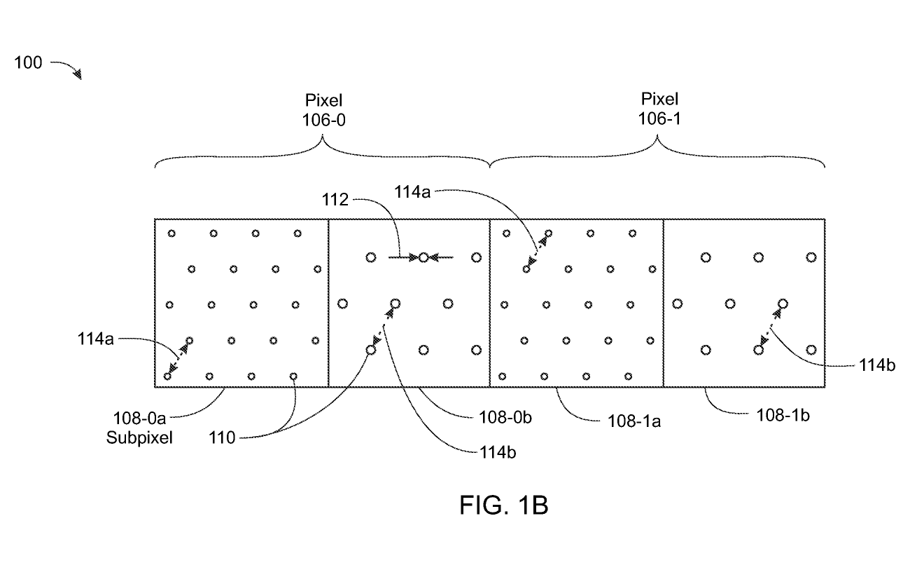

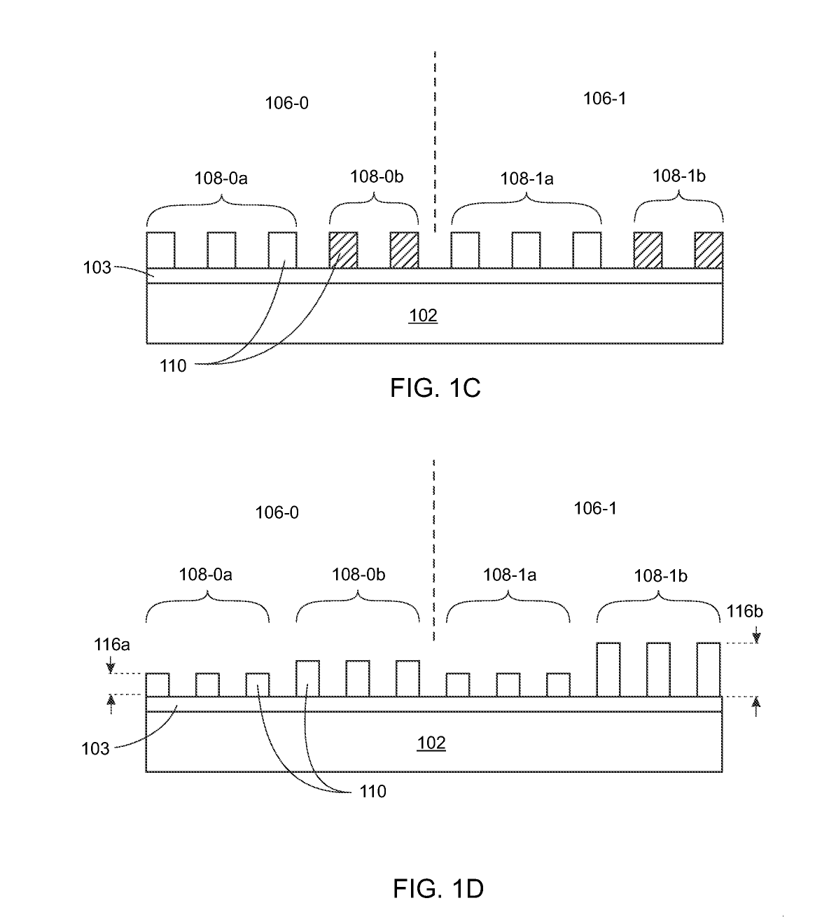

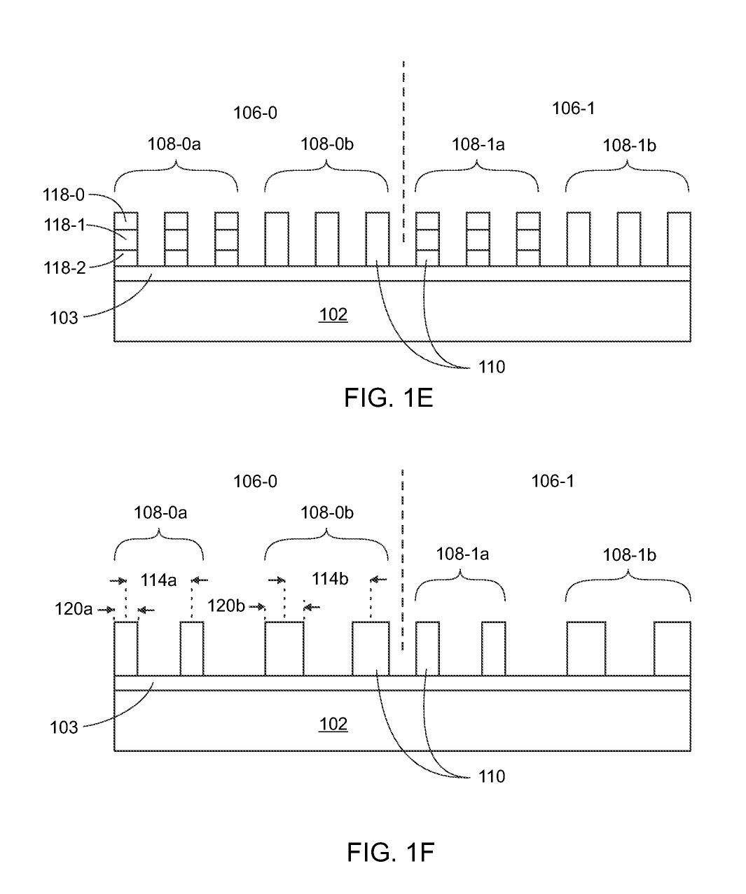

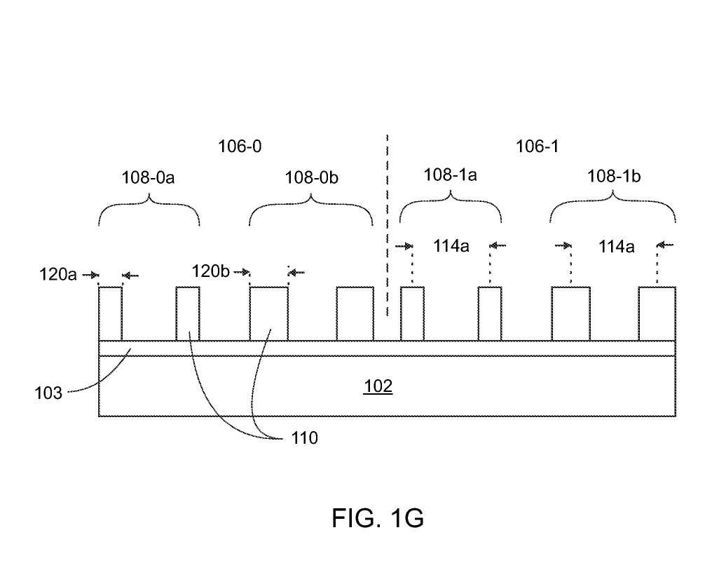

FIGS. 1A through 1G are partial cross-sectional and plan views of a multi-structure pixel device. The device 100 comprises a substrate 102 and a conductive layer 103 with a top surface 104. A plurality of pixels is formed overlying the top surface 104. Shown are pixels 106-0 and 106-1, which may be referred to as “pixel 106” when features common to all pixels are described. Each pixel 106 comprises a plurality of subpixels, which may be referred to as “subpixel 108” when features common to a plurality of subpixels are described. Shown are subpixels 108-0a and 108-0b, associated with pixel 106-0, and subpixels 108-1a and 108-1b, associated with pixel 106-1. Note: only two pixels, with two subpixels each, are shown for simplicity. It should be understood that device 100 is not limited to any particular number of pixels, or subpixels per pixel. In one aspect, as shown in FIGS. 1A and 1B, each subpixel 108 comprises a plurality of structures 110 having a diameter 112. Each subpixel 108 is associated with a corresponding pitch between structures 110. For example, the pitch 114-a between structures 110 in subpixel 108-0a may be different than the pitch 114-b between structures in subpixel 108-0b. Further, the structures 110 in subpixel 108-1a may have the same pitch (114-a) as in subpixel 108-0a, and the structures in subpixel 108-1b may have the same pitch (114-b) as in subpixel 108-0b.

Further, as shown in FIG. 1C, each subpixel 108 may be associated with a corresponding structure material. For example, the structure material (white) of subpixels 108-0a and 108-1a may be different than the structure material (cross-hatched) of subpixels 108-0b and 108-1b.

In another aspect, as shown in FIG. 1D, each subpixel may be associated with a corresponding structure height. For example, the structure height 116-a of subpixels 108-0a and 108-1a may be different than the structure height 116-b of subpixels 108-0b and 108-1b.

In another aspect, as shown in FIG. 1E, the structures 110 in at least one subpixel are formed from a plurality of layered materials. For example, the structures 110 in subpixels 108-0a and 108-1a may be made from material layers 118-0, 118-1, and 118-2. However, it should be noted that the device is not limited to any particular number of layers. The structures 110, whether layered or not may be made from Ag, Au, Al, Pt, Si, Ge, GaN, CdSe, Fe, Ni, Co, Bi, CdS, Type III-IV compounds, Type II-VI compounds, or combinations of the above-mentioned materials.

In one aspect, as shown in FIG. 1F, a plurality of subpixels 108 in each pixel 106 is associated with corresponding structure diameters. That is, the structure diameters between different subpixels may vary. For example, the structures 110 in subpixels 108-0a and 108-1a may have diameter 120-a, and the structures in subpixels 108-0b and 108-1b may have diameter 120-b. As shown, the pitch 114a in subpixels 108-0a and 108-1a is different from the pitch 114b in subpixels 108-0b and 108-1b. In one aspect, as shown in FIG. 1G, each subpixel is associated with a corresponding structure diameter and a common pitch between structures. For example, the structures 110 in subpixels 108-0a and 108-1a may have diameter 120-a and pitch 114-a, and the structures in subpixels 108-0b and 108-1b may have diameter 120-b and pitch 114-a. As applied to all the figures, the structure diameters may be in the range of 5 to 500 nanometers (nm) and the pitch 114 may be in the range of 50 to 1000 nm.

Typically, the structures 110 in each subpixel 108 are formed in an approximately hexagonal array. Depending on the process, the anodizing aluminum films results in arrays with varying degrees of irregularity. These can generally be described as having a local or short-range hexagonal order, but not long-range hexagonal order. An array not having a long range hexagonal order is referred to herein as having an approximately hexagonal order.

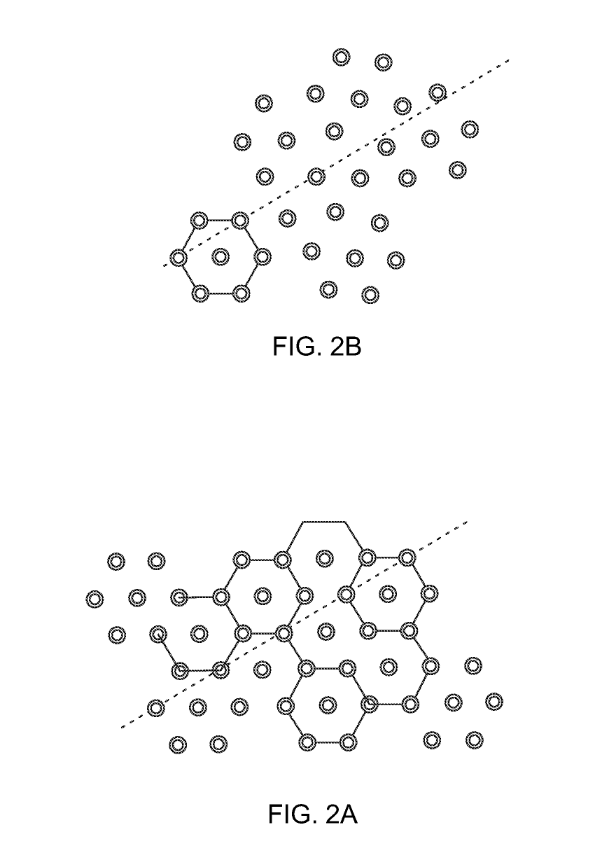

FIGS. 2A and 2B are diagrams depicting, respectively, long-range hexagonal and short-range hexagonal nanoparticle patterns. In FIG. 2A the long-range hexagonal order shows structures at the corner of each hexagon, and at the center of each hexagon. The direction and spacing of structures is regular (highly correlated) over long distances. In FIG. 2B the short-range hexagonal order creates a spacing and direction between structures that becomes uncorrelated over long distances.

Fabrication of the devices of FIG. 1A through 1G to include electrodes, thin-film transistors (TFTs), and a liquid crystal (LC) layer may result in optical devices such as a display, although other optical application would be known to those with skill in the art. One of the functions performed by such an enabled pixel may be to selectively pass light from an underlying backlight (not shown) or to selectively reflect incident light. The substrate 102 in any of the above-mentioned figures may be glass, quartz, silicon (or other semiconductor), or a flexible plastic substrate.

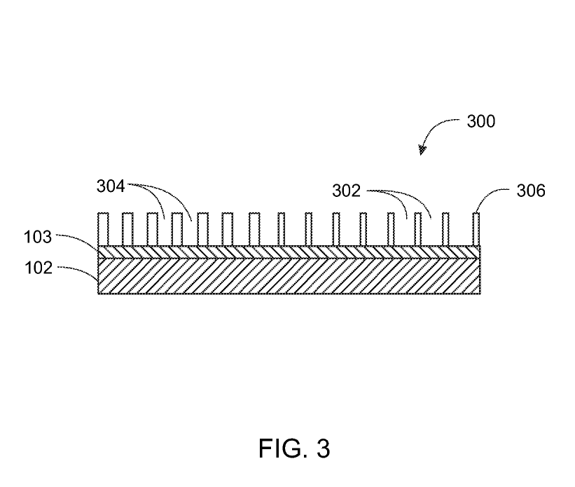

FIG. 3 is a partial cross-sectional view of a membrane structure, which may also be referred to as a multi-structure pixel device. The membrane structure 300 includes a substrate 102, which can be glass, silicon, or flexible plastic substrates, and a conductive layer 103, such as indium tin oxide (ITO). The membrane structure 300 includes a plurality of pores with different pore sizes 302 and 304, arranged in an approximately hexagonal array, and separated by anodized aluminum oxide structures 306. In one aspect, the distance between pores (pitch) remains constant throughout the membrane.

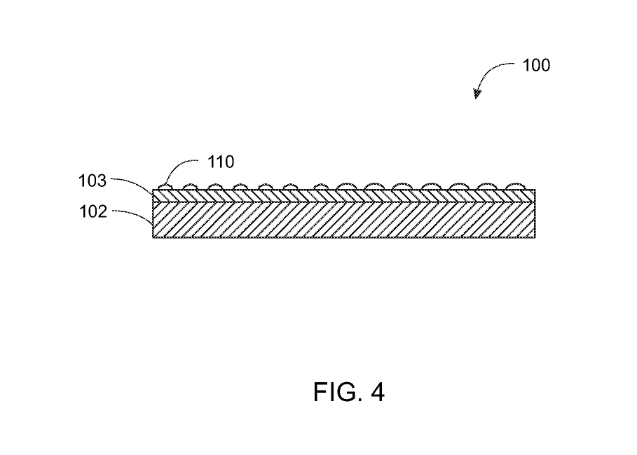

FIG. 4 is a partial cross-sectional view depicting of an ordered array of nanostructures 110 with different diameters formed using the membrane structure of FIG. 3. The nanostructures 110 are in approximately hexagonal array with at least one portion of the substrate having different nanostructure sizes than the other areas on the same substrate. When using nanostructures in display applications, it is advantageous for nanostructures to be in a pixel configuration with each pixel consisting of subpixels having different nanostructure sizes. For example, the nanostructure diameters may be different between subpixels for reflective display application using localized surface plasmon resonance (LSPR) properties. The ordered array of nanostructures in each subpixel is advantageous in achieving a full width half maximum (FWHM) bandwidth of less than 100 nm to improve the color purity of the overall reflected light.

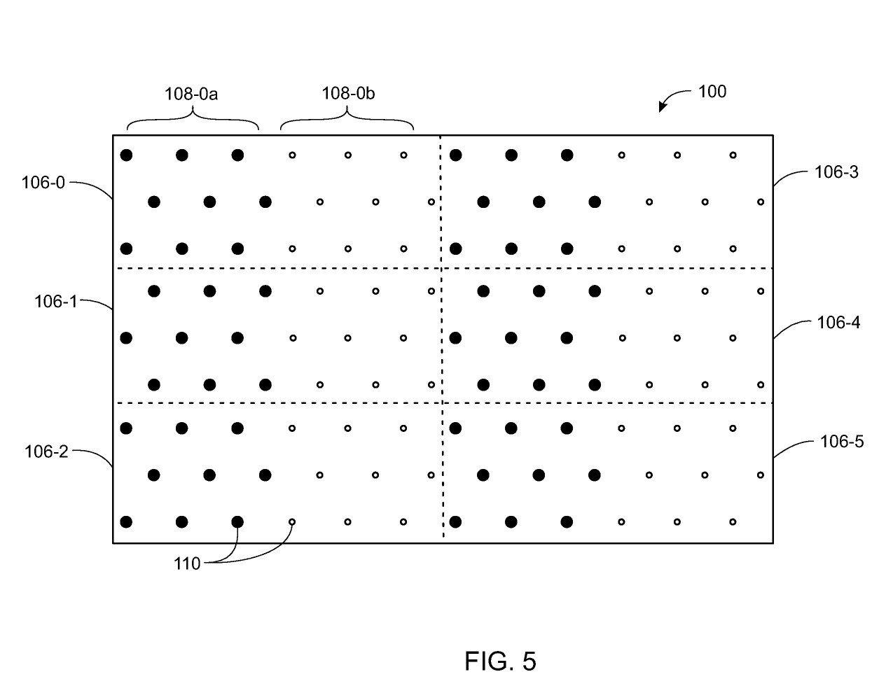

FIG. 5 is a plan view depicting ordered nanostructures arranged in a pixel configuration using an anodized aluminum oxide template as a masking layer. The device 100 may be part of a display panel that includes an array of pixels 106-0 through 106-6, with each pixel consisting of two sub-pixels. As shown, pixel 106-0 includes subpixels 108-0a and 108-0b. For a reflective display application, subpixel 108-0a may be an ordered array of metal structures 110 with a typical diameter of ˜50 nm or larger. Subpixel 108-0b may be an ordered array of metal structures 110 with a different size, for example, a diameter in the range of 50 nm or smaller. The subpixels can be formed from the same metal material such as Ag, or the two subpixels can have different material, such as one subpixel having Ag structures and other subpixel having Al structures, or a hybrid of Ag and Al structures.

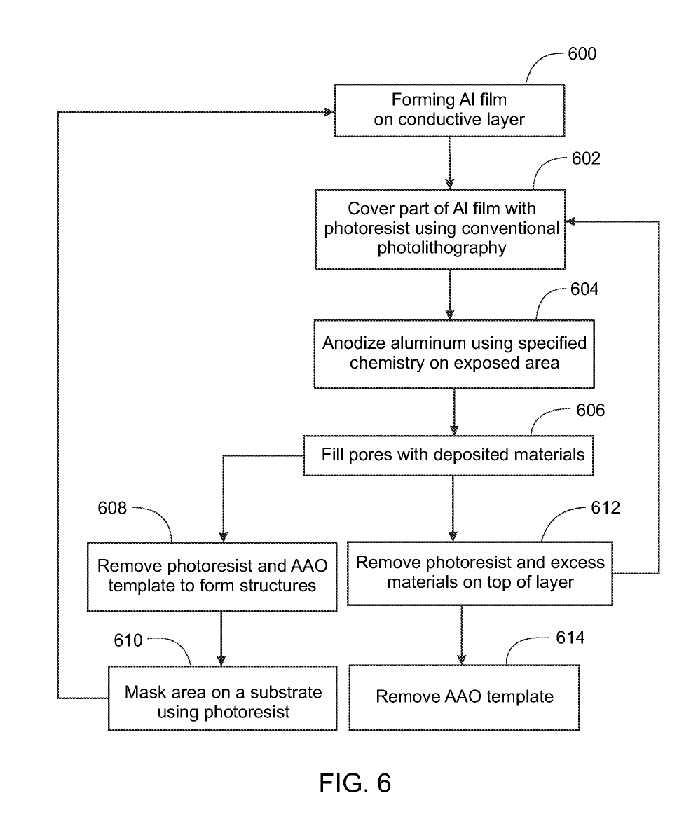

FIG. 6 is a flowchart illustrating a method for preparing a membrane structure and forming multiple ordered arrays of structures with different sizes. The method begins with step 600, with an aluminum film formed on a substrate conductive layer. After forming the Al film on the substrate conductive layer, the film is patterned with conventional photolithography (Step 602). Photoresist with a thickness of 1˜5 μm may be spin-coated and patterned to cover the portion of the Al film with the photoresist sacrificial layer. Having a thick photoresist promotes the planarization of the sacrificial layer above the film to the point that a lithographic pattern can be achieved. Step 604 anodizes the exposed regions of Al film. Specifically, an anodized layer is formed from high-purity aluminum at a voltage appropriate for the type of electrolyte solution used, depending on the pore sizes that is being achieved.

The anodization can take place either with a one-step anodization, or with a two-step anodization treatment using a thicker initial aluminum layer, which gives better control of the pore uniformity. In general, the two-step anodization requires the first anodization treatment to take place under low reaction speed conditions for an aluminum thickness in the range of 1 to 100 μm. A film removal treatment is generally carried out after the first anodization using mixed aqueous solution of phosphoric acid and nitric acid, or phosphoric and chromic acid, for an appropriate length of time, from minutes to hours, as is known in the art.

The second anodization treatment is done after removal of the anodized Al from the first step, and after an ordered array of pits has been formed on the aluminum surface by the first anodization treatment. The second anodization is carried out under a method known in the art or under the same conditions used as above for the first anodization. This step is used to selectively form the pitch between pores, and in a separate process, selectively widen the pores. For example, the pore widening may be carried out by immersing the anodized aluminum oxide layer in an aqueous solution of an acid or alkali as to dissolve portions of the template to enlarge the diameter of the pores. Using a different acid and/or voltages for anodization generates different pore sizes and hexagonal pitches. Typical solutions used are acids such as diluted sulfuric acid, oxalic acid, phosphoric acid, nitric acid, or hydrochloric acid. Only the areas of pores that are exposed to the solution are widened by the step, and not the areas of pores under the sacrificial layer. Typical anodization voltages are in the range of 20 to 200 volts.

After anodizing the Al film, Step 606 deposits the target material in the open pores. Some material of interest include metals such as Ag, Au, Al, Pt, or semiconductor materials such as Si, Ge, GaN, CdSe, or any other compound materials. The method of deposition can be physical sputtering, chemical vapor deposition (CVD), electrodeposition (electroplating), or electron beam evaporation. An electron beam evaporation method is likely to deposit materials at the bottom of the pores and not the sidewalls.

It is possible to electrodeposit a variety of metals inside the pores such as Au, Ag, Fe, Ni, Co, Bi, etc. Electrodeposition of Al can be done with a modified procedure involving ionic liquids. The advantages of electrodeposition is that it is a wet chemical process, not a vacuum process (with a controlled environment), and the metal grows from the bottom (conductive layer) up. Unlike sputtering or evaporation, there is no “pinch-off” at the top of the pores, so there is better control over the aspect ratio, even producing vertically oriented nanorods or nanowires if desired. Furthermore, a sequence of different metals can be deposited in the same pore.

Alternatively but not shown, the target material may be performed after the final iteration of Step 610, or after the final iteration of Step 612.

After material deposition in Step 606, the photoresist is removed in Steps 608 or 612 in a solution that dissolves the photoresist, such as acetone or other remover. This step also removes any excess materials deposited on the photoresist, leaving the target materials inside the pores and the AAO template. Steps 602 through 612 are iteratively repeated as necessary to achieve multiple ordered arrays of pores with different diameters, pitches, or both pores and pitches on the same substrate. The deposition materials and the thickness can be altered for every iteration cycle, thereby forming different nanostructures of different sizes. Finally, the AAO template is removed in Step 614 by etching in diluted potassium hydroxide (KOH) or tetramethylammonium hydroxide (TMAH) to form ordered arrays of nanostructures with different structure features on the same substrate.

As an alternative, after removing the photoresist and AAO template in Step 608, Step 610 masks a different region of the conductive layer-covered substrate, and Steps 600 through 610 are iteratively repeated, so that a different AAO template is formed and then removed for each grouping of like subpixels.

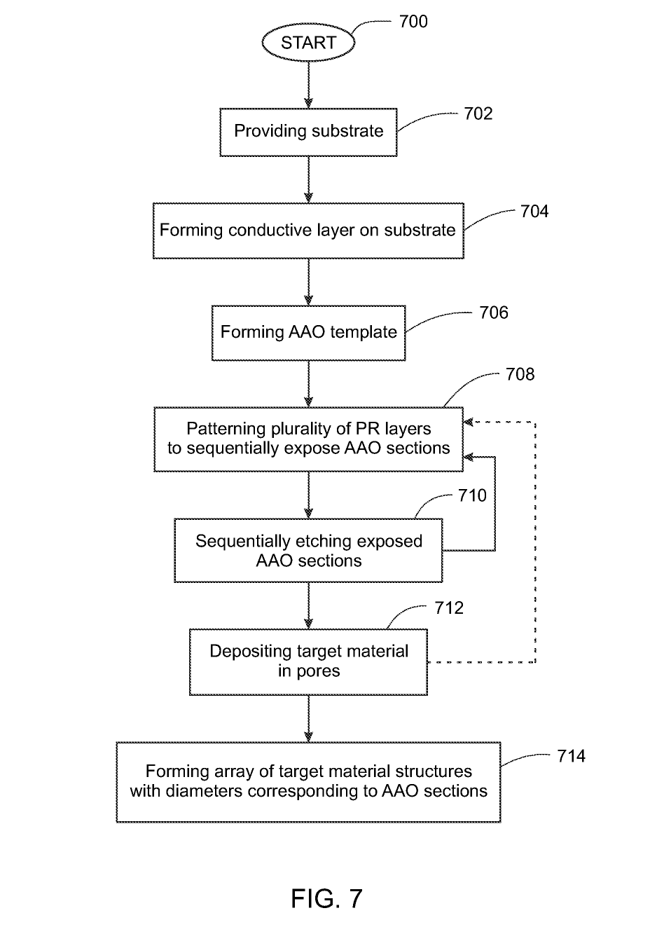

FIG. 7 is a flowchart illustrating a first method for fabricating a multi-structure pore membrane. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 700.

Step 702 provides a substrate, and Step 704 forms a conductive layer, with a top surface, overlying the substrate. Step 706 forms an AAO template with an array of pores exposing underlying regions of the top surface. Typically, the pores are formed in an approximately hexagonal array. Step 708 patterns a plurality of photoresist (PR) layers to sequentially expose a plurality of AAO template sections. Step 710 sequentially etches each exposed AAO template section to widen pore diameters, where each AAO template section is associated with a corresponding pore diameter. Typically, the pitch between pores is in the range from 50 to 1000 nm. Step 712 deposits a target material in the pores of the AAO template. As a result, Step 714 forms an array of target material structures on the top surface, where the target material structures associated with each AAO template section have a corresponding diameter. Typically, the target material structures have a diameter in the range of 5 to 500 nm.

In one aspect, Steps 708 and 710 are iteratively performed, so that in a first iteration the patterning of the plurality of photoresist layers in Step 708 includes forming a first patterned photoresist layer covering a first section of the AAO template and exposing a second section of the AAO template, and sequentially etching each exposed AAO template section in Step 710 includes etching the second section of the AAO template to widen the second section AAO template pores to a first diameter. In the next iteration, Step 708, subsequent to etching the second section of the AAO template in Step 710, forms a second patterned photoresist layer covering the second section of the AAO template and exposing the first section of the AAO template. Then, Step 710 etches the first section of the AAO template to widen the first section AAO template pores to a second diameter. Thus, forming the array of target material structures in Step 714 includes forming target material structures with the first diameter on the top surface region that underlay the second section of the AAO template second section, and target material structures with the second diameter on a top surface region that underlay the first section of the AAO template first section. In one aspect, depositing the target material in the pores of the AAO template in Step 712 includes simultaneously depositing the target material into the pores of the plurality of AAO template sections, subsequent to removing a final photoresist pattern.

Alternatively, as shown with the dotted arrow path, Step 712 sequentially deposits the target material in the pores of each AAO template section, prior to removing each corresponding photoresist pattern. In this aspect each AAO template section may be associated with a corresponding amount of deposition material in the pores, and in Step 714 the target material structures associated with each AAO template section have a corresponding height. In other words, the structures associated with different AAO template sections may have different heights. Further, Step 712 may deposit a selected type of target material in the pores of each corresponding AAO template section. In other words, the structures associated with different AAO template sections may be different materials. In addition, Step 712 may sequentially deposit a plurality of target material types selectively in the pores of at least one AAO template section, if the dotted arrow approach is used, or in all the AAO template sections, if the solid arrow approach is used.

Some examples of the target material that may be deposited in Step 712 include Ag, Au, Al, Pt, Si, Ge, GaN, CdSe, Fe, Ni, Co, Bi, CdS, Type III-IV compounds, Type II-VI compounds, and combinations of the above-mentioned materials. The target material may be deposited using one of the following processes: physical sputtering, chemical vapor deposition (CVD), electrodeposition, or electron beam evaporation.

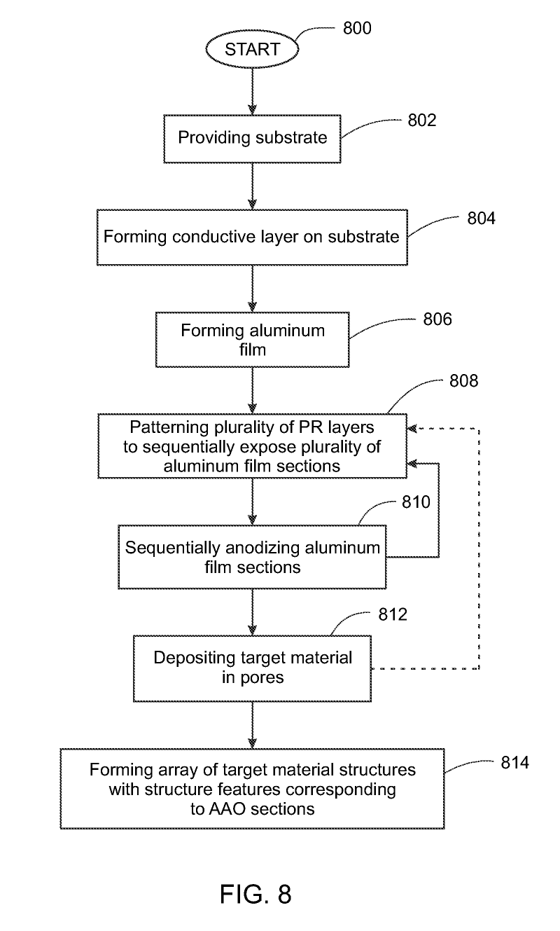

FIG. 8 is a flowchart illustrating a second method for fabricating a multi-structure pore membrane. The method begins as Step 800. Step 802 provides a substrate, and Step 804 forms a conductive layer, with a top surface, overlying the substrate. Step 806 forms an aluminum film over the top surface. Step 808 patterns a plurality of photoresist layers to sequentially expose a plurality of aluminum film sections. Step 810 sequentially anodizes each aluminum film section with a chemistry to form a plurality of AAO template sections with corresponding pore features. The corresponding pore features may be pore diameter, pitch between pores, or both pore diameter and pitch between pores. Typically, an approximately hexagonal array of pores is formed in each AAO template section, with a pitch between pores in the range of 50 to 1000 nm. Step 810 may widen pores in at least one AAO template section. Alternatively stated, Step 810 may be used to control the pore pitch and diameter in each AAO template section.

Step 812 deposits a target material in the pores of the AAO template sections. As a result, Step 814 forms an array of target material structures on the top surface, where the target material structures associated with each AAO template section have a corresponding structure feature. The corresponding structure features may be target material structure diameter, pitch between target material structures, or both target material structure diameter and pitch between target material structures. That is, the target material structures may differ by diameter, pitch, or pitch and diameter, depending AAO template section. Typically, the target material structures have a diameter in the range of 5 to 500 nm.

In one aspect, Steps 808 and 810 are iteratively performed, so that patterning the plurality of photoresist layers in a first iteration of Step 808 includes forming a first patterned photoresist layer covering a first section of the aluminum film and exposing a second section of the aluminum film, and sequentially anodizing each exposed aluminum film section in Step 810 includes anodizing the second section of the aluminum film to form a first pore feature. In the next iteration, Step 808, subsequent to anodizing the second section of the aluminum film, forms a second patterned photoresist layer covering the second section of the aluminum film and exposing the first section of the aluminum film. Then, Step 810 anodizes the first section of the aluminum film to form a second pore feature, and forming the array of target material structures in Step 812 includes forming target material structures with a first structure feature on a top surface region that underlay an AAO template second section, and target material structures with a second structure feature on a top surface region that underlay an AAO template first section.

In one aspect, depositing the target material in the pores of the AAO template in Step 812 includes simultaneously depositing the target material into the pores of the plurality of AAO template sections, subsequent to removing a final photoresist pattern.

Alternatively, Step 812 sequentially deposits the target material into the pores of each AAO template section, prior to removing each corresponding photoresist pattern, see the dotted arrow path. In this aspect, each AAO template section may be associated with a corresponding amount of deposition material in the pores, and in Step 814 the target material structures associated with each AAO template section have a corresponding height. That is, the structure heights associated with different AAO template sections may differ. Further, Step 812 may deposit a selected type of target material in the pores of each corresponding AAO template section. That is, the structure materials associated with different AAO template sections may differ. This deposition approach can be used to selectively deposit (layer) a plurality of different target material types in the pores of at least one AAO template section. Alternatively, if the simultaneous deposition approach is used (solid arrow path), a plurality of different target materials can be formed in the pores of a plurality of AAO template sections.

As noted above, the target material deposited in Step 812 may be Ag, Au, Al, Pt, Si, Ge, GaN, CdSe, Fe, Ni, Co, Bi, CdS, Type III-IV compounds, Type II-VI compounds, or combinations of the above-mentioned materials. The target material may be deposited using a process selected from a group consisting of physical sputtering, CVD, electrodeposition, or electron beam evaporation.

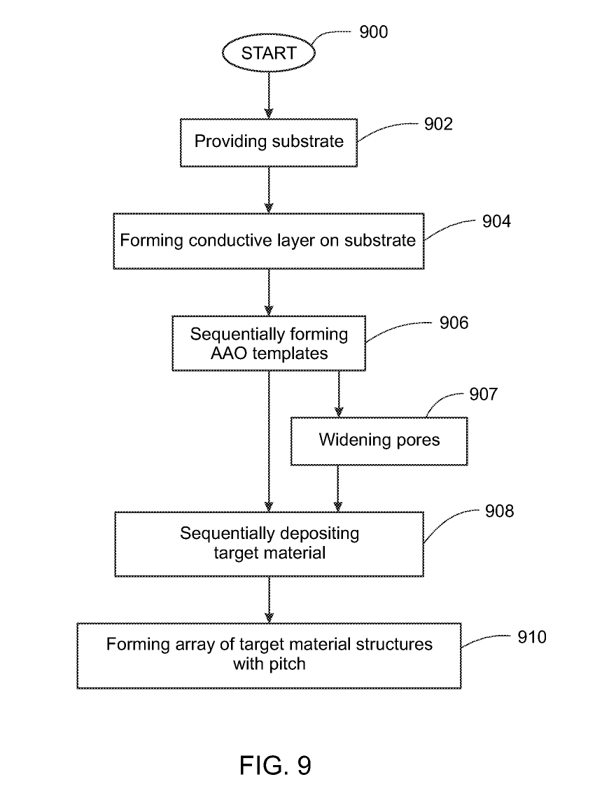

FIG. 9 is a flowchart illustrating a third method for fabricating a multi-structure pore membrane. The method begins at Step 900. Step 902 provides a substrate, and Step 904 forms a conductive layer, with a top surface, overlying the substrate. Step 906 sequentially forms a plurality of AAO templates with an array of pores, having a corresponding plurality of pitches between pores, exposing underlying regions of the top surface. Step 908 sequentially deposits a target material in the pores of the AAO templates. As a result, Step 910 forms an array of target material structures on the top surface, where the target material structures associated with each AAO template have a corresponding pitch between target material structures. In one aspect, Step 907 sequentially etches the AAO templates to widen pore diameters.

Many of the method aspects discussed above in the explanation of FIGS. 7 and 8 can be applied to this third method. These aspects would now be understood by one with skill in the art, as a result of the above-mentioned disclosure, and are not repeated here in the interest of brevity. Alternatively considered, the method of FIG. 9 may be used to form AAO template sections with corresponding pore features, where the corresponding pore features may be pore diameter, pitch between pores, or both pore diameter and pitch between pores.

A multi-structure pixel device and associated fabrication methods have been provided. Examples of particular materials and process steps have been presented to illustrate the invention. However, the invention is not limited to merely these examples. Other variations and embodiments of the invention will occur to those skilled in the art.

We claim:

1. A method for fabricating a multi-structure pore membrane, the method comprising;
providing a substrate;
forming a conductive layer, with a top surface, overlying the substrate;
forming an anodized aluminum oxide (AAO) template with an array of pores exposing underlying regions of the top surface;
patterning a plurality of photoresist layers to sequentially expose a plurality of AAO template sections;
sequentially etching each exposed AAO template section to widen pore diameters, where each AAO template section is associated with a corresponding pore diameter;
depositing a target material in the pores of the AAO template; and,
as a result, forming an array of target material structures on the top surface, where the target material structures associated with each AAO template section have a corresponding diameter.

2. The method of claim 1 wherein patterning the plurality of photoresist layers includes forming a first patterned photoresist layer covering a first section of the AAO template and exposing a second section of the AAO template;
wherein sequentially etching each exposed AAO template section includes etching the second section of the AAO template to widen the second section AAO template pores to a first diameter;
wherein patterning the plurality of photoresist layers includes, subsequent to etching the second section of the AAO template, forming a second patterned photoresist layer covering the second section of the AAO template and exposing the first section of the AAO template;
wherein sequentially etching each exposed AAO template section includes etching the first section of the AAO template to widen the first section AAO template pores to a second diameter; and,
wherein forming the array of target material structures includes forming target material structures with the first diameter on the top surface region that underlay the second section of the AAO template second section, and target material structures with the second diameter on a top surface region that underlay the first section of the AAO template first section.

3. The method of claim 1 wherein depositing the target material in the pores of the AAO template includes simultaneously depositing the target material into the pores of the plurality of AAO template sections, subsequent to removing a final photoresist pattern.

4. The method of claim 1 wherein depositing the target material in the pores of the AAO template includes sequentially depositing the target material in the pores of each AAO template section, prior to removing each corresponding photoresist pattern.

5. The method of claim 4 wherein sequentially depositing the target material into the pores of the plurality of AAO template sections includes each AAO template section being associated with a corresponding amount of deposition material in the pores; and,
wherein forming the array of target material structures on the substrate top surface includes the target material structures associated with each AAO template section having a corresponding height.

6. The method of claim 4 wherein depositing the target material in the pores includes depositing a selected type of target material in the pores of each corresponding AAO template section.

7. The method of claim 1 wherein forming the AAO template with the array of pores includes forming an approximately hexagonal array of pores.

8. The method of claim 1 wherein depositing the target material in the pores includes depositing a material selected from a group Ag, Au, Al, Pt, Si, Ge, GaN, CdSe, Fe, Ni, Co, Bi, CdS, Type III-IV compounds, Type II-VI compounds, and combinations of the above-mentioned materials.

9. The method of claim 1 wherein depositing the target material in the pores includes depositing the target material using a process selected from a group consisting of physical sputtering, chemical vapor deposition (CVD), electrodeposition, and electron beam evaporation.

10. The method of claim 1 wherein forming the array of target material structures on the top surface includes forming target material structures with a diameter in a range of 5 to 500 nanometers (nm).

11. The method of claim 1 wherein depositing the target material in the pores includes sequentially depositing a plurality of target material types in the pores of at least one AAO template section.

12. The method of claim 1 wherein forming the AAO template with the array of pores includes forming a pitch between pores in a range from 50 to 1000 nm.

13. A method for fabricating a multi-structure pore membrane, the method comprising;
providing a substrate;
forming a conductive layer, with a top surface, overlying the substrate;
forming an aluminum film over the top surface;
patterning a plurality of photoresist layers to sequentially expose a plurality of aluminum film sections;
sequentially anodizing each aluminum film section with a chemistry to form a plurality of anodized aluminum oxide (AAO) template sections with corresponding pore features selected from a group consisting of pore diameter, pitch between pores, and both pore diameter and pitch between pores;
depositing a target material in the pores of the AAO template sections; and,
as a result, forming an array of target material structures on the top surface, where the target material structures associated with each AAO template section have a corresponding structure feature selected from a group consisting of target material structure diameter, pitch between target material structures, and both target material structure diameter and pitch between target material structures.

14. The method of claim 13 wherein patterning the plurality of photoresist layers includes forming a first patterned photoresist layer covering a first section of the aluminum film and exposing a second section of the aluminum film;
wherein sequentially anodizing each exposed aluminum film section includes anodizing the second section of the aluminum film to form a first pore feature;
wherein patterning the plurality of photoresist layers includes, subsequent to anodizing the second section of the aluminum film, forming a second patterned photoresist layer covering the second section of the aluminum film and exposing the first section of the aluminum film;
wherein sequentially anodizing each exposed aluminum film section includes anodizing the first section of the aluminum film to form a second pore feature; and,
wherein forming the array of target material structures includes forming target material structures with a first structure feature on a top surface region that underlay an AAO template second section, and target material structures with a second structure feature on a top surface region that underlay an AAO template first section.

15. The method of claim 13 wherein depositing the target material in the pores of the AAO template includes simultaneously depositing the target material into the pores of the plurality of AAO template sections, subsequent to removing a final photoresist pattern.

16. The method of claim 13 wherein depositing the target material in the pores of the AAO template includes sequentially depositing the target material into the pores of each AAO template section, prior to removing each corresponding photoresist pattern.

17. The method of claim 16 wherein sequentially depositing the target material into the pores of the plurality of AAO template sections includes each AAO template section being associated with a corresponding amount of deposition material in the pores; and,
wherein forming the array of target material structures on the top surface includes the target material structures associated with each AAO template section having a corresponding height.

18. The method of claim 16 wherein depositing the target material in the pores includes depositing a selected type of target material in the pores of each corresponding AAO template section.

19. The method of claim 13 wherein sequentially anodizing each aluminum film section includes forming an approximately hexagonal array of pores in each AAO template section.

20. The method of claim 13 wherein depositing the target material in the pores includes depositing a material selected from a group Ag, Au, Al, Pt, Si, Ge, GaN, CdSe, Fe, Ni, Co, Bi, CdS, Type III-IV compounds, Type II-VI compounds, and combinations of the above-mentioned materials.

21. The method of claim 13 wherein depositing the target material in the pores includes depositing the target material using a process selected from a group consisting of physical sputtering, chemical vapor deposition (CVD), electrodeposition, and electron beam evaporation.

22. The method of claim 13 wherein forming the array of target material structures on the top surface includes forming target material structures with a diameter in a range of 5 to 500 nanometers (nm).

23. The method of claim 13 wherein depositing the target material in the pores includes sequentially depositing a plurality of different target material types in the pores of at least one AAO template section.

24. The method of claim 13 wherein sequentially anodizing each aluminum film section includes widening pores in at least one AAO template section.

25. The method of claim 13 wherein sequentially anodizing each aluminum film section includes forming a pitch between pores in a range of 50 to 1000 nm.

26. A method for fabricating a multi-structure pore membrane, the method comprising;
providing a substrate;
forming a conductive layer, with a top surface, overlying the substrate;
sequentially forming a plurality of anodized aluminum oxide (AAO) templates with an array of pores, having a corresponding plurality of pitches between pores, exposing underlying regions of the top surface;
sequentially depositing a target material in the pores of the AAO templates; and,
as a result, forming an array of target material structures on the top surface, where the target material structures associated with each AAO template have a corresponding pitch between target material structures.

27. The method of claim 26 further comprising:
sequentially etching the AAO templates to widen pore diameters.

28. A multi-structure pixel device comprising:
a substrate;
a conductive layer, with a top surface, overlying the substrate;
a plurality of pixels formed overlying the top surface, each pixel comprising a plurality of subpixels; and,
each subpixel comprising a plurality of structures having a diameter, where each subpixel is associated with a corresponding structure diameter and a common pitch between structures.

29. The device of claim 28 wherein each subpixel is associated with a corresponding structure material.

30. The device of claim 28 wherein each subpixel is associated with a corresponding structure height.

31. The device of claim 28 wherein the structures in a first subpixel are formed from a plurality of layered materials.

32. The device of claim 28 wherein the structures in each subpixel are formed in an approximately hexagonal array.

33. The device of claim 28 wherein structures are a material selected from a group Ag, Au, Al, Pt, Si, Ge, GaN, CdSe, Fe, Ni, Co, Bi, CdS, Type III-IV compounds, Type II-VI compounds, and combinations of the above-mentioned materials.

34. The device of claim 28 wherein the structures have a diameter in a range of 5 to 500 nanometers (nm), and a pitch in a range of 50 to 1000 nm.

35. A multi-structure pixel device comprising:
a substrate;
a conductive layer, with a top surface, overlying the substrate;
a plurality of pixels formed overlying the top surface, each pixel comprising a plurality of subpixels;
each subpixel comprising a plurality of structures having a diameter, where each subpixel is associated with a corresponding pitch between structures.

36. The device of claim 35 wherein each subpixel is associated with a corresponding structure material.

37. The device of claim 35 wherein each subpixel is associated with a corresponding structure height.

38. The device of claim 35 wherein the structures in a first subpixel are formed from a plurality of layered materials.

39. The device of claim 35 wherein a plurality of subpixels in each pixel are associated with corresponding structure diameters.

40. The device of claim 35 wherein the structures in each subpixel are formed in an approximately hexagonal array.

41. The device of claim 35 wherein structures are a material selected from a group Ag, Au, Al, Pt, Si, Ge, GaN, CdSe, Fe, Ni, Co, Bi, CdS, Type III-IV compounds, Type II-VI compounds, and combinations of the above-mentioned materials.

42. The device of claim 35 wherein the structures have a diameter in a range of 5 to 500 nanometers (nm), and a pitch in a range of 50 to 1000 nm.
